(19) United States
(12) Patent Application Publication
(10) Pub. No.: US 2003/0135291 A1
(43) Pub. Date: Jul. 17, 2003

(54) Customized ports in a crossbar and method for transmitting data between customized ports and system agents

(76) Inventor: Eric R. DeLano, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/044,401

(22) Filed: Jan. 11, 2002

(51) Int. Cl. G05B 13/02

(52) U.S. Cl. 700/53

(57) ABSTRACT

A crossbar and method for providing connections between a plurality of ports and a plurality of system agents via a processing system, which includes a plurality of ports, each port being capable of being an input port customized for receiving data from a source agent and an output port customized for transferring data to a destination agent, and crossbar control data for specifying crossbar control information for transferring data from an input port to an output port having different port configurations.

The present invention generally relates to customized ports in a crossbar. More specifically, it relates to customized ports in a crossbar and a method for transmitting data on the customized ports in a crossbar.

A crossbar is a chip or chip component commonly used to provide a processing system of high frequency links between multiple ports and system agents. Generally, each port is designed as an input port for receiving data from system agents (i.e., source agents) and an output port for transmitting data from the input ports to other system agents (i.e., destination agents). The system agents can include multiple computer components, such as a central processing unit (CPU), Input/Output (I/O) controllers, memory controllers and cache memory.

More particularly, the requesting agents are generally the CPUs, which can demand different amounts of data depending on the particular requests. The responding agents are generally the Input/Output (I/O) controllers, memory controllers and cache memory, which are also defined by various configurations and bandwidth requirements. As a result of the various agents and the multiple ports, a crossbar is used to sort out the high-frequency links to meet the demands of these competing system agents for multiple ports, which may comprise thousands of different ports. To further the complexity of the processing system, each of the ports are generally divided into multiple virtual communication channels in order to fully utilize the potential of each port.

The ports in a crossbar typically have the same fixed bandwidth for transmission. The problem with a typical crossbar configuration is that it does not effectively deal with the demands of different bandwidth needs for the requesting and responding agents. For example, a requesting agent may require only a fraction of the fixed bandwidth for a particular transmission. Nevertheless, the full fixed bandwidth is used, since all ports in a typical crossbar have the same fixed bandwidth. As a result, bandwidth is wasted in the process. On the other hand, if there is not enough fixed bandwidth designed into the crossbar, performance will also suffer. Furthermore, multiple processors have been used within a single computer, which requires more flexibility in dealing with the different available bandwidth needs. Thus, there is a need for an improved crossbar and method for transmitting data between various system agents and ports.

### BRIEF SUMMARY OF THE INVENTION

The present invention is directed to customized ports in a crossbar. More specifically, it relates to customized ports in a crossbar and a method for transmitting data on the customized ports in a crossbar.

The present invention provides a crossbar for providing connections between a plurality of ports and a plurality of system agents via a processing system, which includes a plurality of ports, with each port being capable of being an input port customized for receiving data from a source agent and an output port customized for transferring data to a destination agent, and crossbar control data for specifying crossbar control information for transferring data from an input port to an output port having different port configurations.

The present invention also provides a method for transmitting data between customized ports and a plurality of system agents in a processing system via a crossbar, which includes the steps of receiving data on an input port, obtaining the destination output port for the data received on the input port, determining whether the input port has the same configurations as the output port, obtaining control information from the crossbar control data when the input port does not have the same configurations as the output port, processing the data according to the obtained control information from the crossbar control data, and transmitting the processed data to the destination output port.

### DESCRIPTION OF THE DRAWINGS

FIG. 1 is a schematic diagram of a simplified prior art crossbar;

FIG. 2 is a schematic diagram of a crossbar in accordance with one embodiment of the present invention;

FIG. 3 is an overall view of the processing system implemented with the crossbar shown in FIG. 2;

FIG. 4 is a flow chart illustrating the preferred functionality of an overall method of the present invention; and,

FIG. 5 is a flow chart illustrating the preferred functionality of a processing method shown in FIG. 4.

### DETAILED DESCRIPTION

Broadly stated, the present invention is directed to a crossbar for providing connections between a plurality of ports and a plurality of system agents via a processing system. The system provides a plurality of ports, each port having an input port customized for receiving input data from a source agent and an output port customized for transferring output data to a destination agent. Crossbar control data for specifying internal crossbar control information for transferring data from an input port to an output port with different port configurations are also included. As a result, the present invention provides a way for ports in a crossbar to be customized and defined according to the needs and implementations selected by the engineers, creating a more flexible crossbar that is better suited to efficiently meet the demands of the various utilization needs of the systems.

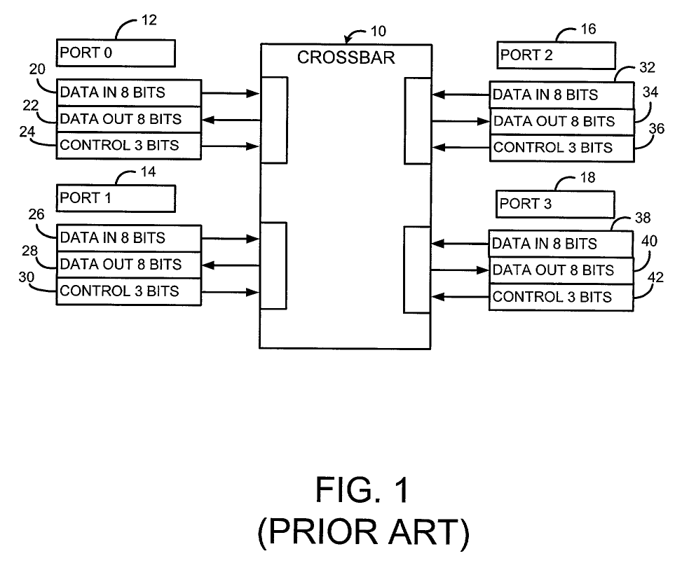

A schematic diagram of a simplified prior art crossbar is shown in FIG. 1, and indicated generally at 10. For simplicity, four (4) ports 12, 14, 16, 18 are shown, specifically port0, port1, port2 and port3. Each port is typically designed as an input port for receiving data from a source agent and an output port for transmitting data from the input port to a destination agent. In particular, as shown in FIG. 1, port0 12 is designed for an input port 20 with an 8 bit data width and an output port 22 with also an 8 bit data width. In other words, an 8 bit length data width is allowed for transmission on port0 12 as input data or output data. Generally, if a connection via the crossbar is N bit wide and operates at a bandwidth of X bit per second, M bit of data will complete a transmission in M/(N*X) seconds. Data received on the input ports typically includes control data 24, which indicates information and/or destination output port relating to the data.

The crossbar, in turn, uses the control information from the control data 24 to negotiate a connection with one of the ports. The crossbar typically uses the control information to verify the validity of port information relating to the data and to obtain the requested destination output port. In this case, a 1 bit length to validate the request, and a 2 bit length to specify the destination port. Control data is well-known in the art, and they vary in bit length and are generally sent from the source agent along with the data received on the input port. A typical crossbar is designed to have the same bandwidth for the input and the output of each port. Thus, every port in the crossbar typically has the same bit length implementation.

In the exemplary prior art crossbar shown in FIG. 1, port1 14 is similarly designed as an 8 bit input port 26 and output port 28 with a 3 bit length for control data 30 to validate the input data and provide a destination port for the input data. Port2 16 is designed as an 8 bit input port 32 and output port 34 with a 3 bit length for control data 36. Similarly, as shown, port3 18 is also an 8 bit input port 38 and output port 40 with a 3 bit length for control data 42. Although the length of the data bit and control bit may vary in conventional crossbars, the ports of the crossbars are all generally set up to have identifical input and output port configurations across all the ports.

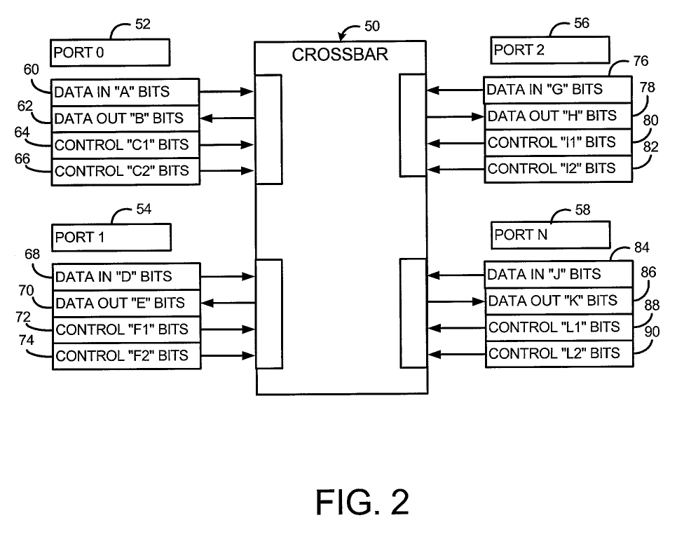

An embodiment of a crossbar designed in accordance with the principles of the present invention is shown in FIG. 2, and indicated generally at 50. For clarification, only 4 ports are shown for the crossbar, specifically port0 52, port1 54, port2 56 and portN 58. As indicated by portN 58, the crossbar can be implemented with as many ports as desired, and the only limitation is the hardware of the computing system. Thus, other implementations of any number of ports for the present crossbar are contemplated and are within the scope of the present invention.

As shown, unlike the prior art, each port of the present crossbar can be customized with different port configurations. In particular, input port0 60 and the output port0 62 of port0 52 are customized to receive “A” data bits and transmit “B” data bits, which indicates different bit lengths for the input port and the output port. Control data 64 generally sent together with data received on the input port0 60 will have “C1” bits. The present invention also includes crossbar control data 66 having “C2” bits that indicates crossbar control information for transferring data from the input port0 62 to an output port0 62 having different port configurations.

The crossbar control data is internal data from the crossbar, which is generated at the time of the design of the crossbar. Unlike the control data 64, the crossbar control data 66 is not sent from the source agents. Rather, the computer engineer provides the crossbar control data at the time when the crossbar with customized ports is created. Thus, the crossbar control data 66 is preferably implemented with the crossbar. In order for the ports with different configurations to work in unison, the crossbar control data 66 is placed internally so that the received data can be correctly formatted for transmission to a port with different configurations (e.g., bandwidth). As a result, even a single port can be customized as an input port and an output port with different port configurations.

The customization and variations of the port configurations can be extended throughout other ports in the crossbar. As shown, port1 54, port2 56 and portN 58 all contain different width configurations. More specifically, port1 54 is customized as a “D” bit width input port 68 and a “E” bit width output port 70 with a “F1” bit width for control data 72 and a “F2” bit width for crossbar control data 74. Similarly, port2 56 is customized as a “G” bit width input port 76 and a “H” bit width output port 78 with a “I1” bit width for control data 80 and a “I2” bit width for crossbar control data 82, and portN 58 is also customized as a “J” bit width input port 84 and a “K” bit width output port 86 with a “L1” bit width for control data 88 and a “L2” bit width for crossbar control data 90.

Although all the ports are shown to have different bandwidth configurations, this is an extreme example to show the flexibility of possible implementations for the present invention. However, in practice, the ports will likely have far less variation, because the implementation may be too complex for the needs of most current processing systems. In addition, in this example, the crossbar control data have been shown with different bandwidth data lengths, and they are specific to the ports. Again, the example provided illustrates the many possibilities and flexibility of the present invention. In practice, there is likely one set of crossbar control data for the whole crossbar, containing only a simple control algorithm.

It is also important to note that although width of the ports is shown as the main port configuration that is customized, other port configurations are contemplated as long as the crossbar control data can be processed in the crossbar. For example, port configuration of frequency may be implemented. Because of the hardware limitation of current chips, width of the ports and bandwidth are generally the main configurations for ports in a crossbar. However, as technology expands in the area, customization of other port configurations may be more practical, and these various implementations are within the scope of the present invention.

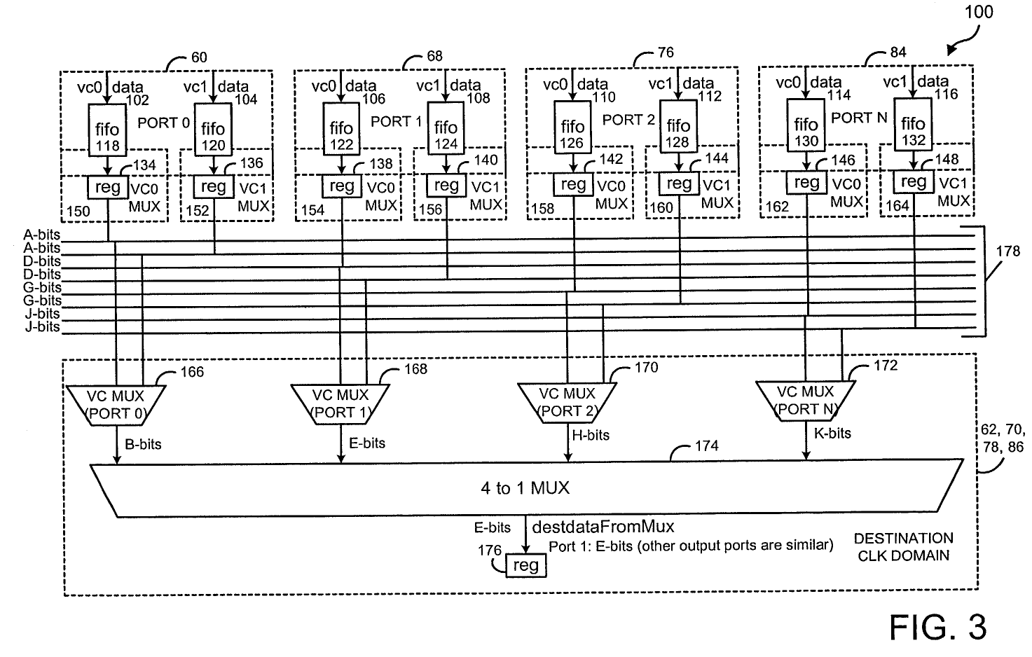

An overall view of the processing system implemented with the present crossbar is shown in FIG. 3, and indicated generally at 100. The preferred implementation includes one or more virtual channels (two of which are shown) for each port for receiving data from a source agent (not shown). In particular, input port0 60 includes virtual channels 102, 104, input port1 68 includes virtual channels 106, 108, input port2 76 includes virtual channels 110, 112 and input port3 84 includes virtual channels 114, 116. As shown, each virtual channel 102, 104, 106, 108, 110, 112, 114, 116 is implemented with a First-In-First-Out (FIFO) buffer respective prioritizing devices 118, 120, 122, 124, 126, 128, 130, 132, respective registers 134, 136, 138, 140, 142, 144, 146, 148, and respective multiplexors (“MUXs”) 150, 152, 154, 156, 158, 160, 162, 164.

The use of virtual channels, MUXs and registers is well established in the art of crossbars. Each input port is divided into multiple virtual channels for receiving data from multiple source agents. Although two virtual channels are shown in FIG. 3 for simplicity, it is typical for each port to be implemented with 5 or more virtual channels. Because each port with the assigned virtual channels is customized differently, a separate register for storing the data in a temporary memory and a MUX for switching configuration internal to the crossbar are preferably implemented for each virtual channel. Depending on the differences and design of the port configurations in the crossbar, an implementation with a fewer number of registers and MUXs may be possible and will be apparent to one skilled in the art.

Data received from the virtual channels are then transmitted to a requested destination output port. As shown, there are also separate MUXs 166, 168, 170, 172 that correspond to the output ports 62, 70, 78, 86, respectively, which are followed by a 4 to 1 MUX 174. The 4 to 1 MUX 174 then transmits the data to a register 176 of one of the destination output ports. Although only one output port is shown for simplicity (i.e., port1 70), there would be 4 output ports having 4 separate registers (one shown) that transmit the data to a destination output port, since the crossbar has 4 ports in the example shown in FIG. 2. As shown on each MUX 166, 168, 170, 172, the bandwidth for each output port (i.e., B-bit, E-bit, H-bit, K-bit) is different from the input ports (i.e., A-bit, D-bit, G-bit, J-bit). As a result, in order for data from the input port to be transmitted to the output port having a different port configuration, the data must be first processed using the control information from the crossbar control data.

Several implementations are contemplated for the processing of data. The crossbar control data can be stored and processed at several places in this example. The crossbar control data can be processed by either the MUX 166, 168, 170, 172 or the 4 to 1 MUX 174 on the output ports. Because of the configuration of the overall system shown in FIG. 3, the crossbar control data are preferably implemented at the output ports 62, 70, 78, 86. However, other implementations at the input ports 60, 68, 76, are also contemplated. For example, the crossbar control data can be processed by either the registers (i.e., a shift register) 134, 136, 138, 140, 142, 144, 146, 148 or the MUXs 150, 152, 154, 156, 160, 162, 164 of the virtual channels 102, 104, 106, 108, 110, 112, 114, 116. As noted, various alternative implementations are contemplated, and they are within the scope of the present invention.

Turning to an important aspect of the illustrated embodiment of the present invention, a flow chart of the preferred functionality of the illustrated embodiment of the present invention is shown in FIG. 3, and indicated generally at 180. After receiving data with the corresponding control data on an input port from a source agent (block 182), the control data of the received data are then read (block 184) and determined whether the control data contain valid information for the data received on the input port (block 186). If not, the process is aborted (block 188), since the control data contained invalid information. If, however, the information from the control data has been verified as valid (block 186), the requested destination output port for the received data is obtained from the control data (block 188).

After the destination output port for the received data is obtained from the control data (block 188), it is next determined whether the input port that received the data has the same port configuration as the obtained destination output port (block 190). If the input port has the same configuration as the output port (block 190), the received data will be transmitted to the destination output port (block 192). If, on the other hand, the input port does not have the same configuration as the output port (block 190), control information is then obtained from the crossbar control data (block 194) for processing the received data to the configuration of the output port (block 196). After the data is processed, the processed data is then transmitted to the output port (block 198).

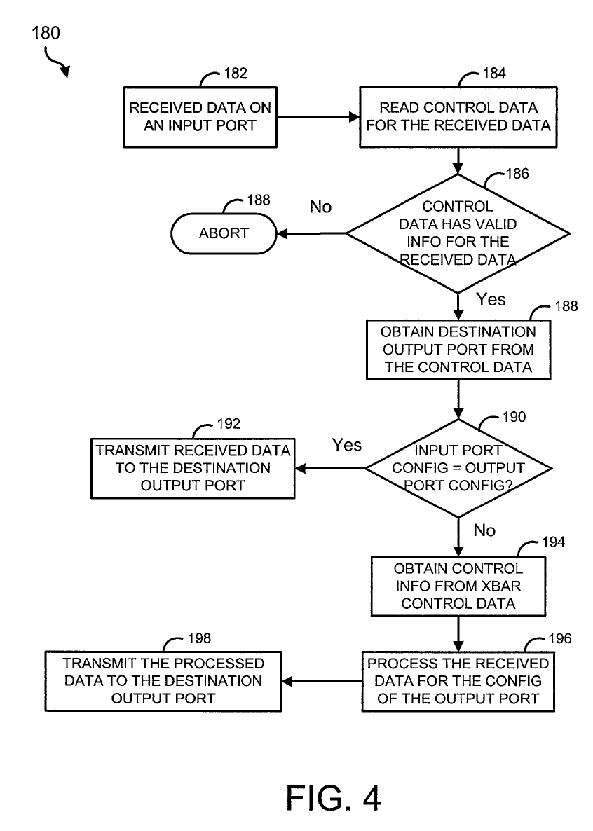

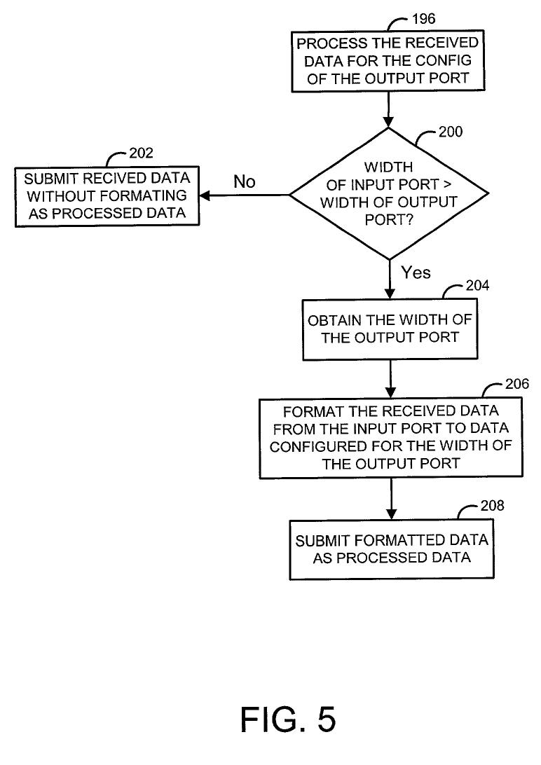

A flow chart illustrating the preferred functionality of the processing step (block 196) shown in FIG. 4 will be explained in FIG. 5. It should be noted that the processing method shown is for processing ports with different width port configurations. However, the present invention contemplates use with other port configurations, and other implementations and methods relating to these port configurations are within the scope of the present invention. Based on port configuration of different widths, the first step in the processing method (block 196) is to determine whether the width of the input port is greater than the width of the output port (block 200). If not, the data are submitted as processed data (block 202) back to the method shown in FIG. 4, since it is not necessary to format data with smaller length bit that can be read by width with greater length bit. In other words, a 24 bit width port can read any data bits that are equal to or fewer than 24 bit length, but not data that are more than 24 bit length.

However, if the width of the input port is more than the width of the output port (block 200), modification to the data is necessary in order to transmit the data to a port with less available width. Thus, the width of the output port must be ascertained (block 204) in order to format the data from the input port to data configured for the width of the output port (block 206). The formatted data will be submitted as the processed data. In practice, the data will be transmitted by shifting the data bits to the width of the output port. For example, if a 24 bit width input port requests to transmit data to an output port with an 8 bit width, the data will then be shifted or divided into 8 bit for each transmission. Since there are 24 bits total, the data will be transmitted 8 bits at a time until all 24 bits are sent. This can be done either through the use of a MUX or a shift register. Various methods can be used and they will be apparent to one skilled in the art. However, it should be noted that these various other methods are within the scope of the present invention.

From the foregoing description, it should be understood that an improved system and method for providing connections between a plurality of customized ports and a plurality of system agents have been shown and described, which have many desirable attributes and advantages. The system and method provide a way for ports in a crossbar to be customized and defined according to the needs and implementations selected by the engineers, creating a more flexible crossbar that is better suited to meet the demands of the various utilization needs of the systems.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A crossbar for providing connections between a plurality of ports and a plurality of system agents via a processing system comprising:
a plurality of ports, each port capable of being an input port customized for receiving data from a source agent and an output port customized for transferring data to a destination agent; and,
crossbar control data for specifying crossbar control information for transferring data from an input port to an output port having different port configurations.

2. The crossbar according to claim 1 wherein the data received on the input port further comprises control data for indicating validity and destination information relating to data received on the input port.

3. The crossbar according to claim 1 further comprising at least one register on each input port and each said output port for storing data in memory.

4. The crossbar according to claim 1 further comprising at least one shift register on each input port for storing data in memory and shifting data with larger bit length to a smaller bit length data for transmission from an input port with more width to an output port with less width.

5. The crossbar according to claim 1 further comprising at least one multiplexor device on each said input port and each said output port for prioritizing transmissions of data.

6. The crossbar according to claim 1 wherein an input port and an output port of at least one of said plurality of ports are customized to have different widths.

7. The crossbar according to claim 1 wherein a plurality of said input ports are customized to have different width.

8. The crossbar according to claim 1 wherein a plurality of said output ports are customized to have different width.

9. The crossbar according to claim 1 wherein said crossbar control data contain control information for formatting bit length of data from an input port to be transmitted to an output port with less width than the input port.

10. The crossbar according to claim 1 wherein said crossbar control data contain control information for use by any one from the group of a shift register or a multiplexor device.

11. A crossbar having a plurality of paths for providing connections between a plurality of ports and a plurality of system agents via a processing system comprising:
a plurality of ports, each port capable of being an input port customized for receiving data from a source agent and an output port customized for transferring data to a destination agent;
a plurality of virtual communication channels on each input port; and,
crossbar control data for specifying crossbar control information for transferring data from a virtual communication channel to an output port having different configurations.

12. A method for transmitting data between customized ports and a plurality of system agents in a processing system via a crossbar, wherein the crossbar includes a plurality of ports, each port capable of being an input port customized for receiving data from a source agent and an output port customized for transferring data to a destination agent, and crossbar control data for specifying crossbar control information for transmitting data from an input port to an output port having different port configurations, the method comprising the steps of:
receiving data on an input port;
obtaining the destination output port for the data received on the input port;
determining whether the input port has the same configuration as the output port;
obtaining control information from the crossbar control data when the input port does not have the same configurations as the output port;
processing the data according to the obtained control information from the crossbar control data; and,
transmitting the processed data to the destination output port.

13. The method according to claim 12 wherein said step of receiving data further comprises the steps of:
reading control data received with the data on the input port;
determining whether the control data have valid port information; and,
aborting when the control data does not have valid port information.

14. The method according to claim 13 wherein said step of obtaining the destination output port further comprises the step of obtaining the destination output port from the control data when the control data has valid port information.

15. The method according to claim 12 wherein said step of processing the data further comprising the steps of:
determining whether the width of the input port is more than the width of the output port;
submitting the data as the processed data when the width of the input port is not more than the width of the output port;
obtaining the width of the output port when the width of the input port is greater than the width of the output port;
formatting the data from the input port to data configured for the obtained width of the output port; and,
submitting the formatted data as the processed data.

16. A system for transmitting data between customized ports and a plurality of system agents in a processing system via a crossbar, wherein the crossbar includes a plurality of ports, each port capable of being an input port customized for receiving data from a source agent and an output port customized for transferring data to a destination agent, and crossbar control data for indicating crossbar control information for transmitting data from an input port to an output port having different port configurations, comprising:
a storage medium;
a machine for transmitting data between customized ports and a plurality of system agents in a processing system via a crossbar, the machine comprising a set of instructions for:
receiving data on an input port;
obtaining the destination output port for the data received on the input port;
determining whether the input port has the same configuration as the output port;
obtaining control information from the crossbar control data when the input port does not have the same configurations as the output port;
processing the data according to the obtained control information from the crossbar control data; and,
transmitting the processed data to the destination output port.

17. A machine for transmitting data between customized ports and a plurality of system agents in a processing system via a crossbar, the machine comprising a set of instructions to:
receive data on an input port;
obtain the destination output port for the data received on the input port;
determine whether the input port has the same configuration as the output port;
obtain control information from the crossbar control data when the input port does not have the same configurations as the output port;
process the data according to the obtained control information from the crossbar control data; and,
transmit the processed data to the destination output port.
